(19) United States
(12) Patent Application Publication
(10) Pub. No.: US 2015/0055132 A1
(43) Pub. Date: Feb. 26, 2015

(54) METHOD FOR CALIBRATING SPECTROSCOPY APPARATUS AND EQUIPMENT FOR USE IN THE METHOD

(71) Applicant: RENISHAW DIAGNOSTICS LIMITED, Glasgow, Strathclyde (GB)

(72) Inventors: Alastair Ricketts, Glasgow (GB); Karen Fitchett, Oxford (GB); Julie Green, Lanark (GB); Colette Dalton, Glasgow (GB)

(21) Appl. No.: 14/389,954

(22) PCT Filed: Apr. 2, 2013
(86) PCT No.: PCT/GB2013/050863

§ 371 Date: Oct. 1, 2014

(30) Foreign Application Priority Data
Apr. 5, 2012 (EP) 12163382.0

(51) Int. Cl. G01N 21/65; G01J 3/44

(52) U.S. Cl. CPC G01N 21/65; G01J 3/44
USPC 356/301

(57) ABSTRACT

This invention concerns a method of calibrating spectroscopy apparatus including illuminating a reference sample, identifying spectrum from light emitted from the sample and calibrating the spectroscopy apparatus based upon the spectrum, wherein the reference sample has been dried. The invention also concerns a reference sample for use in this method and a kit including such a reference sample. The reference sample may be lyophilised dye labelled oligonucleotides.

### FIELD OF INVENTION

This invention concerns a method for calibrating spectroscopy apparatus and equipment for use in the method. The invention has particular, but not exclusive, application to the calibration of Raman spectroscopy apparatus to be used in the identification of dye labelled nucleic acid sequences in a sample.

### INTRODUCTION

It is known to use Raman spectroscopy to identify a molecule in situ in a sample. However, Raman spectroscopy used in its basic form often lacks the sensitivity to identify molecules, particularly when attempting to detect multiple analytes simultaneously in a single interrogation. To enhance the Raman signal, surface enhanced resonance Raman scattering (SERRS) may be used. SERRS uses the principal that the molecule to be identified is absorbed on an active surface and comprises a chromophore having an electronic transition in the region of the laser wavelength used to excite the Plasmon on the enhancing surface.

For a biological sample, to provide a sufficiently distinct chromophore for each type of molecule to be identified, the sample may be treated to attach different dyes to each type of molecule to be identified (eg different types of oligonucleotides). Examples of such techniques are described in WO09/022,125 and US2006246460, which are incorporated herein by reference. In order to accurately detect the Raman signal produced by the dye labelled oligonucleotide it may be necessary to calibrate the Raman spectroscopy apparatus to take into account factors specific to that apparatus.

One method for calibrating the system is for the user to apply the dyes to plates, independent from the sample, and carry out Raman spectroscopy of these plates to identify the Raman spectra that occur for those dyes. Knowledge of the spectra can then be used when analysing the processed sample to determine if any of the dyes are present. A problem with this technique is that the user may make errors when applying the dyes to the plates and the technique is time consuming. This is particularly the case for SERRS where the exact method of applying the dye to the surface is crucial.

US2010/0291599 discloses a technique for automatically calibrating Raman spectroscopy apparatus using reference samples built into the apparatus. A problem with such a technique is that it assumes the response of the reference sample remains unchanged over time. This problem is acknowledged in U.S. Pat. No. 5,850,623, which attempts to overcome this problem through the use of a complex correction algorithm established through the irradiation of a plurality of reference samples.

WO2006/134376 is directed towards a similar problem. This document discloses a method for identifying the presence of probe/target complex molecules using Raman spectroscopy without the use of labels. A problem with the technique is that exposure of the SERS chip to sample solution may result in a change in an efficiency of the chip. To calibrate for this change, the chip comprises probe regions for receiving the sample interspersed with calibration regions, which contain calibration molecules. These calibration regions can be used for calculating a normalization factor to calibrate the instrument for changes in overall SERS efficiency during application of the sample.

### SUMMARY OF INVENTION

According to a first aspect of the invention there is provided a method of calibrating spectroscopy apparatus comprising illuminating a reference sample, identifying a spectrum from light emitted from the sample and calibrating the spectroscopy apparatus based upon the spectrum, characterised in that the reference sample has been dried.

It is believed that drying of a reference sample, and, optionally, subsequent rehydration, does not significantly change the characteristic spectra obtained from the reference sample. Accordingly, the spectrum obtained from such a reference sample can be used for calibrating the spectroscopy apparatus for identifying substances corresponding to that of the reference sample. Drying of the reference sample lengthens the time over which characteristic spectrum can be obtained from the reference sample allowing storage of the reference sample before use in calibrating spectroscopy apparatus. Furthermore, the reference sample can be prepared in a controlled environment and then delivered to the location of the spectroscopy apparatus for calibration of the apparatus. This may ensure consistency and reduce the likelihood of human error.

In a preferred arrangement, the dried reference sample has been lyophilised on a substrate. A reference sample that has been dried in this way may retain the critical structures that produce the characteristic spectrum on which a calibration can be based. Alternatively, the reference sample may have been dried by another method, for example, air dried or, for samples that can withstand high temperatures and/or pressures, supercritical drying.

The reference sample may be an organic reference sample. In one embodiment, the reference sample comprises dye labelled oligonucleotides. The dried reference sample may be treated with one or more reagents before spectra are obtained. The reagents may be the same reagents used to treat samples of unknown elements. The reagents may be used in substantially the same relative quantities as that used to treat the samples of unknown elements. In this way, the conditions under which spectroscopy is carried out is consistent for both the reference sample and the sample(s) of unknown elements. Alternatively, additional reagents may be used or there may be a difference in the relative quantities of the reagents from that used to treat the samples of unknown elements, for example, to compensate for the fact that the reference sample is or has been dried. For example, a greater proportion of water may be used with the reference sample to take account of the relatively high water retention of the reference sample. The reagents used may be one or more selected from water, spermine and silver or gold colloid.

The light emitted by the reference sample may be scattered light, for example the method may comprise identifying from the scattered light a Raman spectrum for calibrating Raman spectroscopy apparatus. The invention has particular application to Surface Enhanced Resonance Raman spectroscopy (SERRS). However, the method may be used for other forms of spectroscopy, such as fluorescence spectroscopy.

The method may be carried out automatically by the spectroscopy apparatus. For example, the dried reference sample may be stored within the apparatus, the apparatus arranged to direct illumination laser light at the sample periodically for calibrating the apparatus. The apparatus may comprise multiple reference samples, each sample comprising a different label, such as a dye. For example, different dyes may be arranged to attach to different target molecules such that the presence of a particular dye corresponds to the presence of a particular target molecule in the sample. The apparatus may have to be calibrated for each dye that is used.

Calibrating the spectroscopy apparatus may comprise updating a library of component reference spectra with the spectrum of the reference sample. Such a library of component reference spectra may be used in direct classical least squares (DCLS) analysis of a spectrum from an unknown sample, such as the modified DCLS method described in European patent application 11250530.0. Accordingly, it will be understood that “calibrating the spectroscopy apparatus” as used herein is intended to include updating/adjusting reference spectra used to analyse a spectrum in order to take into account factors that may have changed since the previous reference spectra fewer obtained.

Accordingly, a second aspect of the invention provides a method of calibrating spectroscopy apparatus comprising illuminating a reference sample, determining a spectrum characteristic of the reference sample from light emitted from the sample and updating a library of component reference spectra with the spectrum characteristic of the reference sample.

Such a method may be carried out periodically and/or immediately before using the spectroscopy apparatus to determine components present in an unknown sample.

According to a third aspect of the invention there is provided a reference sample for use in calibrating spectroscopy apparatus, the reference sample comprising lyophilised dye labelled oligonucleotides.

Lyophilising the dye labelled oligonucleotide preserves the dye labelled oligonucleotides such that properties of the material remain substantially unchanged between formation of the reference sample and calibration of spectroscopy apparatus.

The reference sample may comprise a substrate on to which the dye labelled oligonucleotides are lyophilised. The reference sample may comprise a plurality of different dye types lyophilised to the substrate. The substrate may comprise an array of wells, each well comprising a different dye. The reference sample may or may not require processing before use in calibrating spectroscopy apparatus, for example reagents may be applied to the reference sample.

According to a fourth aspect of the invention there is provided a kit for calibrating spectroscopy apparatus comprising labels for attaching to target molecules that are potentially present in an organic sample and a dried reference sample comprising the labels and organic matter.

According to a fifth aspect of the invention there is provided a method of calibrating Raman spectroscopy apparatus comprising illuminating a reference sample and identifying a Raman spectrum from light scattered from the sample that is characteristic of the reference sample, characterised in that the reference sample has been stabilized without significantly altering the Raman spectrum that is obtained from that which would have been obtained from the reference sample before the reference sample was stabilized.

It will be understood that the term “the reference sample has been stabilized” means that the reference sample has been placed in a state from which it does not significantly change for a longer period, such as weeks, months or years longer, than would have been the case if the reference sample had not been stabilized.

The Raman spectrum identified as characteristic of the reference sample may be used as a reference for use in a method for determining components/elements present in a sample. For example, the identified Raman spectrum may be used in a Direct Least Squares method (DCLS) for identifying components present in a sample, such as the modified DCLS method described in European patent application 11250530.0.

### BRIEF DESCRIPTION OF DRAWINGS

Embodiments of the invention will now be described, by example only, with reference to the accompanying drawings, in which:—

FIG. 1 is a flowchart showing a method according to one embodiment of the invention;

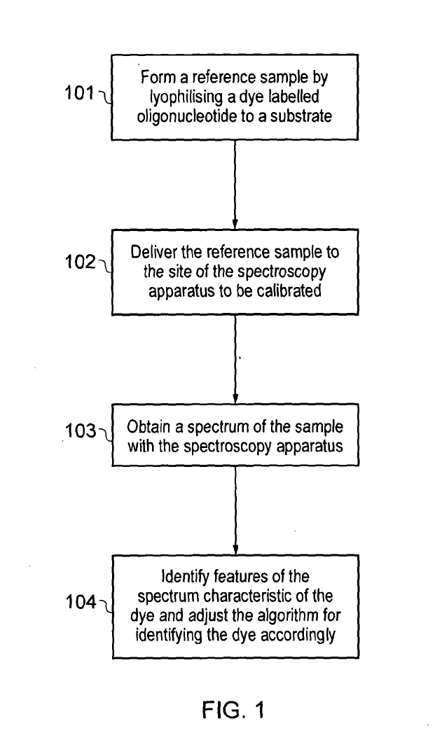

FIG. 2 shows Raman spectroscopy apparatus according to the invention;

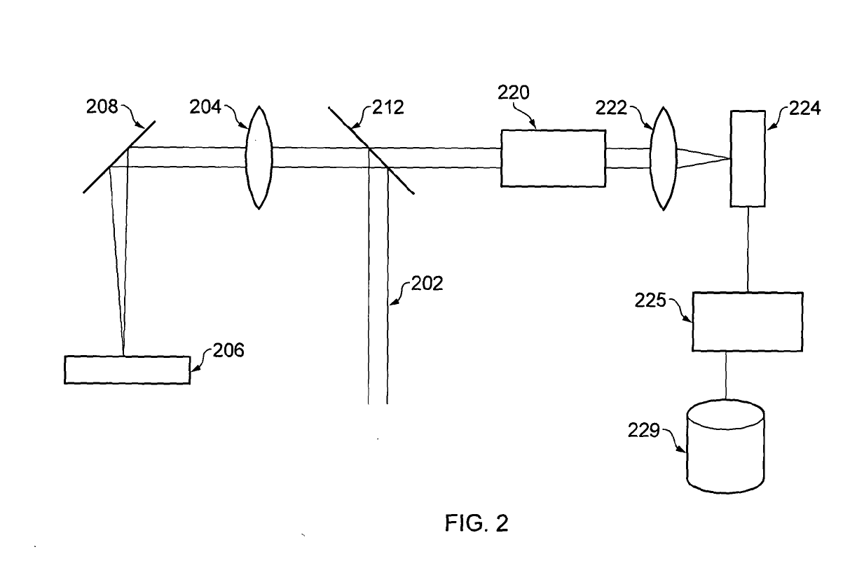

FIG. 3 is a cross-section of a reference plate according to one embodiment of the invention;

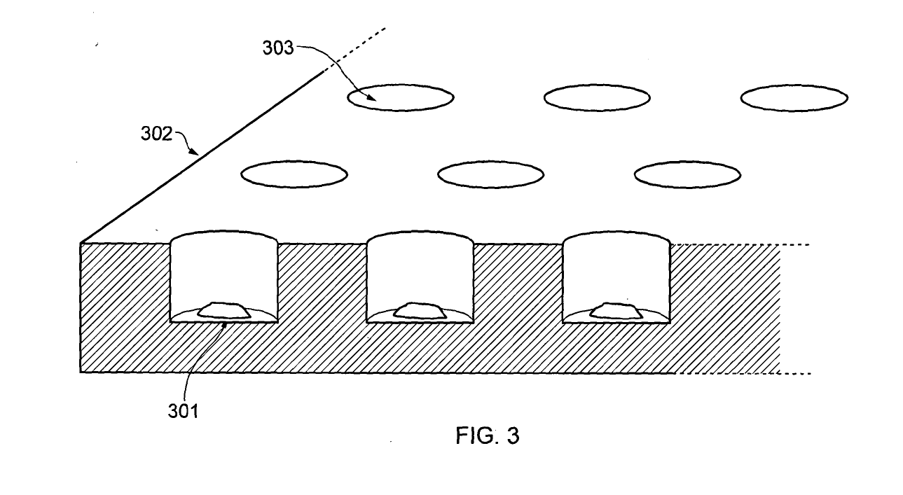

FIG. 4 is a graph showing the Raman spectrum of a TET control plate and TET lyophilised plate according to the invention that has been stored for 1 week;

FIG. 5 is a graph showing average SERRS intensity for specified Raman peaks of different dyes of air dried reference plates stored for 1, 2, 3, 4 and 5 weeks at 4° C.;

FIG. 6 is a graph showing average SERRS intensity for specified Raman peaks of different dyes of air dried reference plates stored for 1, 2, 3, 4 and 5 weeks at −20 C;

FIG. 7 is a graph showing average SERRS intensity for specified Raman peaks of different dyes of lyophilised reference plates stored for 1, 2, 3, 4 and 5 weeks at 4° C.; and

FIG. 8 is a graph showing average SERRS intensity for specified Raman peaks of different dyes of lyophilised reference plates stored for 1, 2, 3, 4 and 5 weeks at −20° C.;

### DESCRIPTION OF EMBODIMENTS OF THE INVENTION

Referring to the drawings, a method of calibrating spectroscopy apparatus comprises forming a reference sample by lyophilising 101 dye labelled oligonucleotides 301 on to a substrate, in this case a micro plate 302. In this embodiment, the plate comprises an array of wells 303, with each well containing a different dye corresponding to the set of dyes to be used in analysing a sample. The set of dyes may be in accordance with those set out in European patent application 12163369.7. The dye labelled oligonucleotides may be lyophilised to the substrate in a controlled environment to reduce the risk of contamination of the reference sample.

Once the reference sample has been prepared, the reference sample is delivered 102 to a site of the spectroscopy apparatus 201 to be calibrated. The reference sample may be delivered as part of a kit of parts for carrying out medical diagnostics. For example, the kit may comprise the reference plate 302 and a set of dyes corresponding to the plurality of reference samples for labelling oligonucleotides in a sample to be analysed.

To calibrate a spectroscopy apparatus 201, the reference plate 302 is treated with one or more reagents corresponding to those to be used to treat unknown samples to be analysed. In this embodiment, the reagents are water, spermine and silver colloid. The treated reference plate 302 is then placed on a table (not shown) of the spectroscopy apparatus and illuminated with a laser 202. Light scattered by the reference sample is detected.

A Raman spectroscopy apparatus will typically comprise a dichroic filter 212 placed at 45 degrees to the optical path to reflect the laser beam 202 towards the sample 206. The laser beam 201 then passes though an objective lens 204, which focuses it to a spot or line at a focal point on the sample and, optionally, a mirror 208 for redirecting the beam towards the sample. Light is scattered by the sample, collected by objective lens 204 and collimated into a parallel beam, which passes back through dichroic filter 212. The filter 212 rejects Raleigh scattered light having the same wavelength as the laser beam and transmits Raman scattered light of a different wavelength. The Raman scattered light then passes to Raman analyser 220.

The Raman analyser 220 comprises a dispersive element, such as a diffraction grating, that disperses the scattered light into a spectrum, which is focussed by lens 222 onto a suitable photo-detector. In this embodiment, the photo-detector is a charge-coupled device (CCD) 224. The photo-detector is connected to a computer 225, which acquires data from the photo-detector 224 and analyses the data as required.

When calibrating the apparatus, computer 225 may identify from light scattered from the reference sample a Raman spectrum characteristic of the dye used to label the oligonucleotides. The spectrum may be specific to that spectroscopy apparatus as a result of shifts in the spectrum resulting from changes in specific aspects of the apparatus and the local environment at that time, such as the ambient temperature. The identified Raman spectrum is stored in data storage 229, for example as part of a library, for later use as reference component spectra in a DCLS analysis of an unknown sample such as described in European patent application 11250530.0.

Calibration of the spectroscopy apparatus may be carried out periodically or each time an unknown sample is to be analysed.

### Example 1

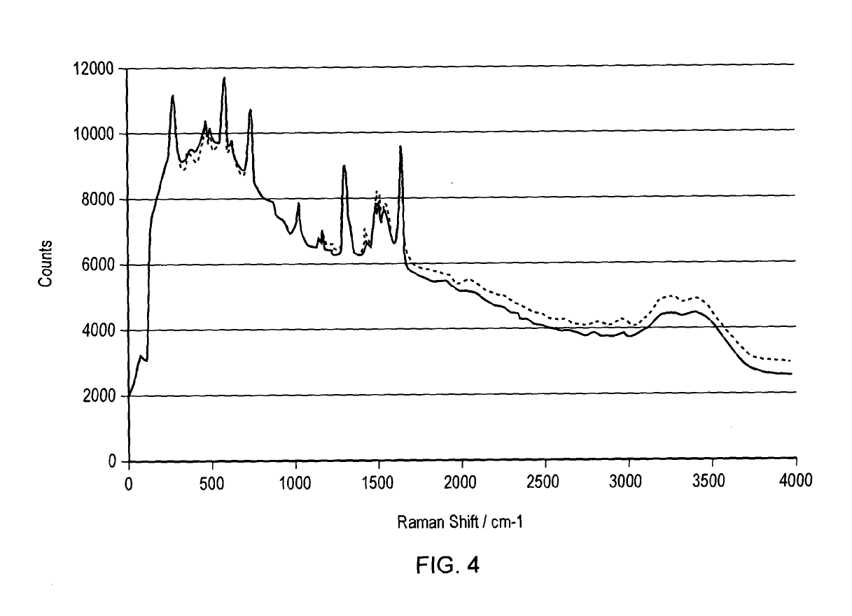

A dye phosphoramidite (trade name TET) was lyophilised on to a plate and stored in a fridge at 4° C. for 1 week. The plate was then treated with reagents, water, spermine and a colloid, and a Raman spectrum obtained. A Raman spectrum of a control plate of TET was also obtained. The two Raman spectra are illustrated in FIG. 4. The Raman spectrum of the control plate is shown as a solid black line and the Raman spectrum of the lyophilised plate is shown as a dotted line. As can be seen, the Raman spectrum of the lyophilised plate substantially matches that of the control plate.

### Example 2

### Method

Plates were prepared with 5 repetitions of each dye and blanks. The dyes were added to each plate in accordance with the plate set-up shown in the table below:

| | 1 | 2 | 3 | 4 | 5 | 6 | 7 | 8 | 9 | 10 | 11 | 12 |
|---|---|---|---|---|---|---|---|---|---|---|---|---|
| A | TET | TAM | R.G. | Cy3 | HEX | MAX | TYE | 488 | 565 | Blank | | |
| B | TET | TAM | R.G. | Cy3.5 | HEX | MAX | TYE | 488 | 549 | Blank | | |
| C | TET | JOE | R.G. | Cy3.5 | HEX | MAX | 520 | 488 | 549 | Blank | | |
| D | TET | JOE | R.G. | Cy3.5 | FAM | MAX | 520 | 488 | 549 | | | |
| E | TET | JOE | Cy3 | Cy3.5 | FAM | MAX | 520 | 565 | 549 | | | |
| F | TAM | JOE | Cy3 | Cy3.5 | FAM | TYE | 520 | 565 | 549 | | | |
| G | TAM | JOE | Cy3 | HEX | FAM | TYE | 520 | 565 | Blank | | | |
| H | TAM | R.G. | Cy3 | HEX | FAM | TYE | 488 | 565 | Blank | | | |

The dye labelled oligonucleotides were diluted in concentrations shown in the table below from a 1×10⁻⁶ M stock solution in 0.15% polysorbate 20 (Tween-20). A 2.5 μL aliquot of dye labelled oligonucleotides was added to each well of the microplate and allowed to dry (either through air drying or using a Lyophiliser).

### Dye List Detailing Concentration Used

| Dye | Concentration (M) |
|---|---|
| TET | 2 × 10⁻⁸ |
| TAMRA | 2 × 10⁻⁸ |
| JOE | 2 × 10⁻⁸ |
| Rho Green | 2 × 10⁻⁸ |
| Cy3 | 1 × 10⁻⁸ |
| Cy3.5 | 2 × 10⁻⁸ |
| HEX | 2 × 10⁻⁸ |
| FAM | 4 × 10⁻⁸ |
| BHQ2 | 5 × 10⁻⁷ |
| MAX | 2 × 10⁻⁸ |
| TYE | 2 × 10⁻⁸ |
| TEX | 1.5 × 10⁻⁷ |
| ATTO520 | 4 × 10⁻⁸ |
| ATTO488 | 1 × 10⁻⁸ |
| ATT0565 | 2 × 10⁻⁸ |
| DY549 | 1.5 × 10⁻⁸ |

A Lyophiliser was switched on one hour prior to use to allow the temperature and pressure to equilibrate. Once the oligonucleotides were added the plate, the plate was frozen for 30 minutes and then transferred to the Lyophiliser. The plate remained in the Lyophiliser for 3 hours and then removed and stored in one of three storage conditions, namely room temperature, 4° C. and −20° C.

Analysis of the plate with the Raman spectroscopy apparatus at 2.5% laser power for 1 second with a single accumulation.

### Part 1

The plates were stored at room temperature, 4° C. and −20° C., sealed using a sealing plate, chillout wax or no seal and stored in upright or inverted positions. One plate was prepared according to each condition (therefore, 18 for each drying process) in addition to a control plate. The control plate was prepared immediately prior to analysis. Therefore, in total 37 plates were analysed.

### Part 2

The plates were stored at 4° C. and −20° C., sealed using a sealing plate and stored in an upright position. Three plates were prepared according to each condition plus three control plates. Therefore, in total 15 plates were analysed.

### Part 3

The conditions set out in Part 2 were repeated but using only 2 plates for each condition and 2 control plates. The plates were prepared for weekly analysis at 1, 2, 3 and 4 weeks.

### SERRS Analysis

The following peaks were chosen for each dye, their SERRS intensity recorded and relative standard deviations calculated:

| TET | 1636 cm⁻¹ |
|---|---|
| TAMRA | 1653 cm⁻¹ |
| JOE | 1503 cm⁻¹ |
| Rho Green | 1368 cm⁻¹ |
| Cy3 | 1589 cm⁻¹ |
| Cy3.5 | 1520 cm⁻¹ |
| HEX | 1503 cm⁻¹ |
| FAM | 1542 cm⁻¹ |
| MAX | 1512 cm⁻¹ |
| TYE | 1589 cm⁻¹ |
| 520 | 1359 cm⁻¹ |
| 488 | 1645 cm⁻¹ |
| 565 | 1653 cm⁻¹ |
| 549 | 1394 cm⁻¹ |

### Results

### Part 1

Before the peaks where chosen, the spectra from each plate were examined and general observations recorded. The details of the air dried and Lyophiliser plates of part 1 are shown in the two tables below.

### Observations from Air Dried Plates

| Plate | Dyes giving poor signal |
|---|---|
| RT P U | JOE, Cy3, Cy3.5, MAX, TYE, 549 |
| RT P I | Cy3, Cy3.5, TYE |
| RT C U | Cy3, Cy3.5, MAX, TYE, 549 |
| RT C I | Cy3, Cy3.5, TYE |
| RT N U | Cy3, Cy3.5, TYE |
| RT N I | Cy3, Cy3.5, TYE |
| 4 P U | Cy3, Cy3.5, TYE |
| 4 P I | Good all round performing |
| 4 C U | Cy3, Cy3.5, MAX, TYE |
| 4 C I | Cy3, Cy3.5, TYE |
| 4 N U | Cy3, Cy3.5, TYE |
| 4 N I | Cy3, Cy3.5, TYE |
| 20 P U | Good all round performing |
| 20 P I | Cy3, Cy3.5, TYE |
| 20 C U | Good all round performing |
| 20 C I | Cy3, Cy3.5, TYE |
| 20 N U | Good all round performing |
| 20 N I | Cy3, Cy3.5, TYE |
| Control Plate | Cy3, Cy3.5, TYE (signals a bit low) |

### Observations of Lyophiliser Plates

| Plate | Dyes giving poor signal |
|---|---|
| RTPU | Similar to control plate |
| RTPI | Similar to control plate |
| RTCU | MAX |
| RTCI | Similar to control plate |
| RTNU | Similar to control plate |
| RTNI | MAX |
| 4PU | Best so far |
| 4PI | Best so far |
| 4CU | Similar to control plate |
| 4CI | Similar to control plate |
| 4NU | Similar to control plate |
| 4NI | Similar to control plate |
| 20PU | Similar to control plate |
| 20PI | Similar to control plate |
| 20CU | MAX |
| 20CI | TYE |
| 20NU | Similar to control plate |
| 20NI | Similar to control plate |

The abbreviations for the plates refer to the conditions in which the plates were stored and are as follow:

RT=Room temperature
P=Plate seal

### U=Upright

### I=Inverted

### C=Chillout wax

N=No seal

### 4=4° C.

### 20=−20° C.

Observations indicate that the lyopholiser plates gave better quality spectra in that the spectra were most similar to the spectra from the control plate.

For part 1 plates, an approximate peak height was estimated using the highest value on the axis of SERRS intensity for each spectrum, which roughly corresponded to the peak intensity of the most intense peak of the spectrum. Results for both the air dried and lyophiliser plates are summarised in the tables below:

Summary of peak intensity data form air dried plates

| | TET | TAMRA | JOE | Rho Green | Cy3 | Cy3.5 | HEX | FAM | MAX | TYE | 520 | 488 | 565 | 549 |
|---|---|---|---|---|---|---|---|---|---|---|---|---|---|---|
| RT P U | 12500 | 15000 | 4800 | 5000 | 3500 | no peaks | 7000 | 5000 | 2500 | 2000 | 11000 | 6000 | 7500 | 8000 |
| RT P I | 13000 | 17500 | 6500 | 7500 | 4000 | 3000 | 8500 | 5500 | 3500 | 2300 | 21000 | 12500 | 7500 | 9000 |
| RT C U | 8000 | 12500 | 4500 | 5000 | 3500 | no peaks | 7000 | 5500 | 3000 | 2500 | 12000 | 10000 | 7500 | 6000 |
| RT C I | 7500 | 15000 | 6500 | 6000 | 3500 | 3000 | 9000 | 4500 | 2500 | 2000 | 15000 | 10000 | 8000 | 11000 |
| RT N U | 11000 | 16000 | 5500 | 7000 | 4000 | 3000 | 8000 | 6500 | 4000 | 3000 | 14000 | 10000 | 8000 | 9000 |
| RT N I | 9500 | 18000 | 4500 | 6000 | 3500 | no peaks | 9000 | 6000 | 3000 | 2500 | 16000 | 12000 | 8000 | 9000 |
| 4 P U | 12000 | 17000 | 5500 | 8000 | 4500 | 3500 | 10000 | 6500 | 2500 | 2500 | 13000 | 13000 | 8000 | 9000 |
| 4 P I | 14000 | 18000 | 7000 | 8000 | 4500 | 3500 | 10000 | 6000 | 2500 | 2000 | 13000 | 14000 | 8000 | 9000 |
| 4 C U | 8000 | 13000 | 5000 | 6500 | 3500 | no peaks | 9000 | 5500 | 1800 | 1500 | 12000 | 9000 | 7000 | 9000 |
| 4 C I | 9000 | 13000 | 5500 | 7000 | 3500 | 3000 | 10000 | 6000 | 2500 | 2500 | 13000 | 13000 | 7500 | 8000 |
| 4 N U | 11000 | 13000 | 5000 | 7000 | 3500 | 3000 | 8000 | 5500 | 2500 | 2000 | 12000 | 11000 | 8000 | 8500 |
| 4 N I | 10000 | 13000 | 5500 | 8000 | 3500 | 3000 | 9000 | 5500 | 2000 | 2000 | 11000 | 14000 | 7500 | 10000 |
| 20 P U | 10000 | 14000 | 5500 | 7500 | 4000 | 3500 | 8000 | 6000 | 2500 | 2000 | 12000 | 12000 | 8000 | 10000 |
| 20 P I | 14000 | 16000 | 7000 | 9000 | 4500 | 3500 | 11000 | 6000 | 2500 | 2000 | 14000 | 15000 | 9000 | 11000 |
| 20 C U | 8000 | 14000 | 6000 | 6000 | 4000 | 3000 | 10000 | 5500 | 2000 | 2000 | 14000 | 13000 | 8000 | 10000 |
| 20 C I | 7000 | 13000 | 5500 | 7000 | 3500 | 3000 | 9000 | 4000 | 3000 | 2500 | 13000 | 12000 | 7000 | 10000 |
| 20 N U | 14000 | 15000 | 6000 | 9000 | 4500 | 4000 | 11000 | 6000 | 2500 | 2000 | 13000 | 15000 | 9000 | 11000 |
| 20 N I | 15000 | 15000 | 7000 | 10000 | 4000 | 3500 | 11000 | 6000 | 2500 | 2000 | 13000 | 17000 | 9000 | 10000 |
| Control | 16000 | 16000 | 6000 | 8000 | 6000 | 3500 | 12000 | 7000 | 3000 | 3500 | 14000 | 13000 | 10000 | 11000 |

Summary of peak intensity data form lyophilised plates

| | TET | TAMRA | JOE | Rho Green | Cy3 | Cy3.5 | HEX | FAM | MAX | TYE | 520 | 488 | 565 | 549 |
|---|---|---|---|---|---|---|---|---|---|---|---|---|---|---|
| RT P U | 16000 | 16500 | 9000 | 8500 | 6500 | 3500 | 10000 | 8500 | 3000 | 3000 | 13500 | 15000 | 9500 | 11500 |
| RT P I | 13000 | 14500 | 8000 | 9500 | 6500 | 3500 | 9500 | 6500 | 2500 | 2500 | 12000 | 11500 | 8000 | 10000 |
| RT C U | 9000 | 13500 | 5000 | 6500 | 4500 | 3000 | 8000 | 5500 | 3000 | 2000 | 12500 | 11500 | 8000 | 9500 |
| RT C I | 10500 | 12000 | 5500 | 6000 | 4000 | 3000 | 7500 | 5000 | 2500 | 2500 | 10500 | 11000 | 7500 | 10500 |
| RT N U | 15000 | 16500 | 7500 | 7000 | 6500 | 4000 | 10000 | 7500 | 3500 | 3000 | 11500 | 13000 | 8000 | 9500 |
| RT N I | 9500 | 14500 | 6000 | 8500 | 5000 | 3000 | 8500 | 6500 | 2000 | 2500 | 12500 | 11000 | 8500 | 8500 |
| 4 P U | 12500 | 17500 | 9500 | 9500 | 5500 | 3500 | 9000 | 6500 | 3000 | 3500 | 10000 | 13000 | 8500 | 10000 |
| 4 P I | 15000 | 15500 | 8500 | 10500 | 7000 | 4500 | 12000 | 7500 | 2500 | 3000 | 12000 | 14500 | 8500 | 9000 |
| 4 C U | 11500 | 13000 | 6000 | 6500 | 4500 | 3000 | 8500 | 5500 | 2500 | 2500 | 12000 | 12000 | 8500 | 9500 |
| 4 C I | 12500 | 14500 | 6500 | 7500 | 4500 | 3500 | 10000 | 6000 | 2000 | 2500 | 11500 | 12500 | 7500 | 9000 |
| 4 N U | 14500 | 15000 | 8500 | 9500 | 5500 | 4000 | 10000 | 7000 | 2500 | 3000 | 11000 | 13000 | 9000 | 10000 |
| 4 N I | 15000 | 17000 | 9500 | 10000 | 6000 | 4500 | 8500 | 7000 | 2500 | 2500 | 11500 | 15000 | 9000 | 11000 |
| 20 P U | 14500 | 15000 | 9500 | 10500 | 7000 | 4000 | 10500 | 7000 | 2500 | 2500 | 10500 | 14000 | 9000 | 10000 |
| 20 P I | 16500 | 16000 | 8500 | 10500 | 7000 | 4500 | 10500 | 7500 | 2500 | 2500 | 12000 | 16000 | 10000 | 11000 |
| 20 C U | 12000 | 13500 | 7000 | 7000 | 4000 | 3000 | 8000 | 5500 | 2000 | 2000 | 13000 | 10000 | 8000 | 9000 |
| 20 C I | 9500 | 12000 | 5500 | 8000 | 5000 | 3500 | 10000 | 5000 | 2000 | 1500 | 10000 | 10500 | 7000 | 88500 |
| 20 N U | 13500 | 13500 | 9000 | 9000 | 6000 | 4000 | 9500 | 6500 | 3000 | 2500 | 12500 | 12500 | 8500 | 9500 |
| 20 N I | 14500 | 15500 | 9500 | 10500 | 5500 | 4000 | 10500 | 7000 | 2500 | 2500 | 10000 | 14000 | 8500 | 7500 |

From these results it would appear that:
1) Chillout wax causes a reduction in signal intensity
2) Storage of plates in an inverted position reduces the SERRS signal
3) Plates dried in the lyophiliser produced better quality, more reproducible spectra than air dried plates
4) Storing the plates at room temperature generally results in lower peak intensity than storing the plates at 4° C. or −20° C.

### Part 2

Characteristic SERRS peaks (as detailed above) were chosen for each dye and the average peak intensity determined

Summary of Part 2 results with average peak intensity (within the reps
of each plate) and average between plates also detailed (in bold).

| | Average | TET | TAMRA | JOE | Rho Green | Cy3 | Cy3.5 | HEX | FAM |
|---|---|---|---|---|---|---|---|---|---|
| Air dried | 4PU-1 | 7602.204 | 13656.4 | 5367.28 | 5689.13 | 4069.686 | 3532.672 | 8972.968 | 5647.212 |
| | 4PU-2 | 8269.198 | 12910.87 | 5519.446 | 6072.132 | 4335.976 | 3668.158 | 10327.35 | 5972.175 |
| | 4PU-3 | 7935.701 | 13283.63 | 5443.363 | 5880.631 | 4202.831 | 3600.415 | 9650.16 | 5809.694 |
| Average | | 7935.701 | 13283.63 | 5443.363 | 5880.631 | 4202.831 | 3600.415 | 9650.16 | 5809.694 |
| Lyophiliser | 4PU-1 | 10280.06 | 11622.45 | 8513.096 | 11100.598 | 5170.28 | 4117.07 | 10677.44 | 7895.872 |
| | 4PU-2 | 10021.37 | 12313.34 | 7608.642 | 11043.038 | 4979.256 | 3947.116 | 10023.45 | 8154.688 |
| | 4PU-3 | 10042.87 | 13441.49 | 8902.106 | 11487.752 | 5208.724 | 3986.654 | 11330.02 | 8288.95 |
| Average | | 10114.77 | 12459.09 | 8341.281 | 11210.463 | 5119.42 | 4016.947 | 10676.97 | 8113.17 |
| Air dried | 20PU-1 | 6743.778 | 10768.64 | 5381.69 | 6336.36 | 3725.472 | 3606.952 | 8982.48 | 6696.884 |
| | 20PU-2 | 9010.607 | 12453.18 | 7090.506 | 8991.3532 | 4658.402 | 3839.367 | 10141.53 | 7252.707 |
| | 20PU-3 | 7451.09 | 11038.19 | 6298.536 | 7465.148 | 4042.498 | 3747.566 | 10181.96 | 6794.104 |
| Average | | 7735.158 | 11420 | 6256.911 | 7597.6204 | 4142.124 | 3731.295 | 9768.654 | 6914.565 |
| Lyophiliser | 20PU-1 | 8897.415 | 12078.99 | 7270.45 | 9422.3523 | 4622.295 | 3857.434 | 10222.73 | 7550.084 |
| | 20PU-2 | 10893.08 | 14701.84 | 8218.378 | 11766.692 | 5284.984 | 4212.834 | 10564.45 | 8006.378 |
| | 20PU-3 | 10793.05 | 12626.34 | 7625.76 | 11694.65 | 5431.642 | 4228.006 | 12630.65 | 8655.612 |
| Average | | 10194.52 | 13135.72 | 7704.868 | 10961.231 | 5112.974 | 4099.425 | 11139.28 | 8070.691 |
| Control | Plate 1 | 7351.395 | 8572.52 | 5339.605 | 3218.96 | 1819.262 | 1819.408 | 5729.816 | 6593.11 |
| | Plate 2 | 6521.778 | 6062.102 | 2633.506 | 3262.4975 | 2120.094 | 2000.392 | 5769.102 | 7848.636 |
| | Plate 3 | 6493.584 | 6478.616 | 4045.146 | 4121.466 | 2039.988 | 2202.92 | 6853.936 | 8819.316 |
| Average | | 6788.919 | 7071.079 | 4006.086 | 3534.3078 | 1993.115 | 2007.573 | 6117.618 | 7753.687 |

| | Average | MAX | TYE | 520 | 488 | 565 | 549 |
|---|---|---|---|---|---|---|---|
| Air dried | 4PU-1 | 3615.484 | 4264.922 | 9570.596 | 8846.684 | 6780.468 | 9296.826 |
| | 4PU-2 | 2573.31 | 3684.112 | 9410.023 | 9880.72 | 6452.566 | 8517.548 |
| | 4PU-3 | 3094.397 | 3974.517 | 6500.206 | 6405.135 | 4599.345 | 6121.125 |
| Average | | 3094.397 | 3974.517 | 8493.608 | 8377.513 | 5944.125 | 7978.5 |
| Lyophiliser | 4PU-1 | 2809.43 | 3429.162 | 9983.91 | 12686.6 | 6387.426 | 8005.095 |
| | 4PU-2 | 1826.06 | 2210.076 | 12898.29 | 10127.77 | 6188.326 | 7839.582 |
| | 4PU-3 | 1760.768 | 2 [symbol] 4.888 | 12951.97 | 12298.45 | 6593.75 | 8367.076 |
| Average | | 2132.083 | 2768.042 | 11944.72 | 11704.27 | 6389.834 | 8070.584 |
| Air dried | 20PU-1 | 2974.01 | 3670.04 | 9368.178 | 8206.902 | [symbol] 857.158 | 8595.326 |
| | 20PU-2 | 2527.305 | 3241.606 | 10305.84 | 9972.375 | 5994.281 | 7853.898 |
| | 20PU-3 | 2896.11 | 2990.765 | 11248.39 | 9679.35 | 6478.794 | 9239.298 |
| Average | | 2799.142 | 3300.804 | 10307.47 | 9286.209 | 6110.078 | 8562.841 |
| Lyophiliser | 20PU-1 | 2352.721 | 2924.236 | 11452.9 | 10331.52 | 6250.357 | 8327.627 |
| | 20PU-2 | 1337.215 | 2414.022 | 12069.29 | 11268.51 | 6834.14 | 8103.678 |
| | 20PU-3 | 1481.98 | 1955.992 | 12274.71 | 12003.37 | 6821.59 | 8451.478 |
| Average | | 1723.972 | 2431.417 | 11932.3 | 11201.13 | 6335.362 | 8294.261 |
| Control | Plate 1 | 1215.173 | 1665.618 | 12569.31 | 3596.788 | 3161.942 | 5681.596 |
| | Plate 2 | #DIV/O1 | 1220.174 | 9524.656 | 2886.7 | 2825.132 | 4516.338 |
| | Plate 3 | #DIV/O1 | 1502.814 | 11015.11 | 3636.12 | 2995.592 | 4337.126 |
| Average | | #DIV/O1 | 1462.869 | 11036.36 | 3373.203 | 2994.222 | 4845.02 |

[symbol]

indicates data missing or illegible when filed

From these results it would appear that storage of the plates at the different temperatures has no significant effect on the SERRS intensity. The drying process, however does appear to affect SERRS intensity. For both drying techniques, the Raman peaks are present but lyophiliser drying appears to increase the SERRS intensity (with the exception of MAX and TYE) compared to air drying. For TAMRA and DY549 the SERRS counts were approximately the same, whilst for the remaining dyes the counts were significantly higher.

### Part 3

All dyes with the exception of MAX survived the full 4 weeks. MAX signals disappeared after 1 week and TYE also produced poor quality spectra.

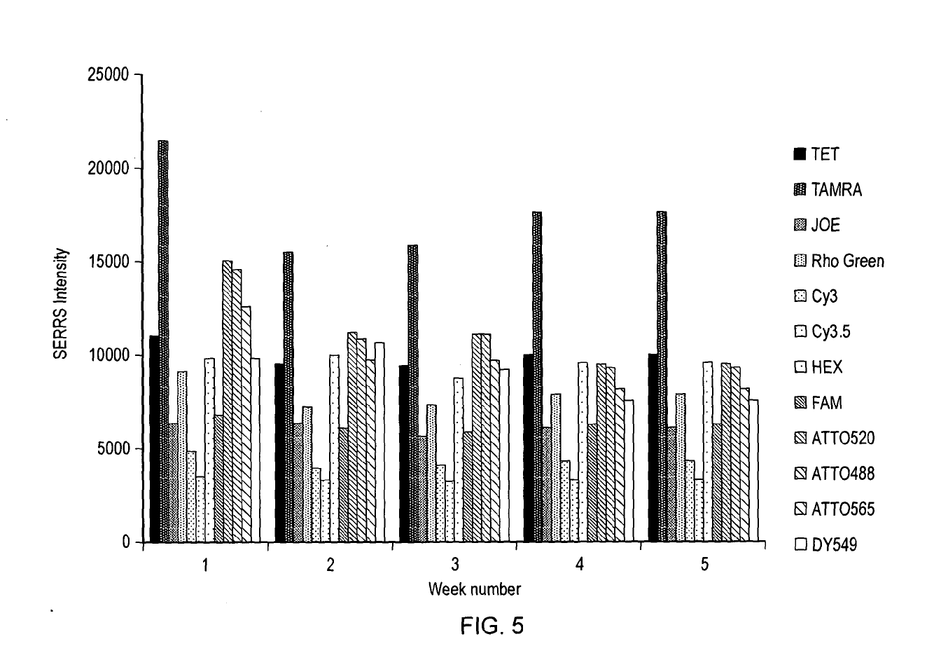

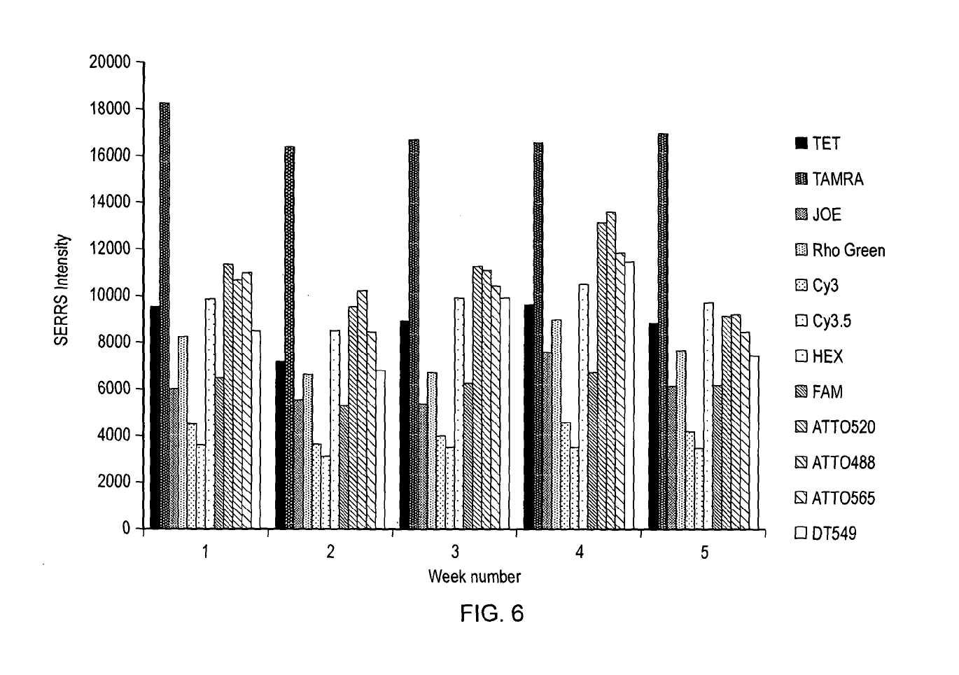

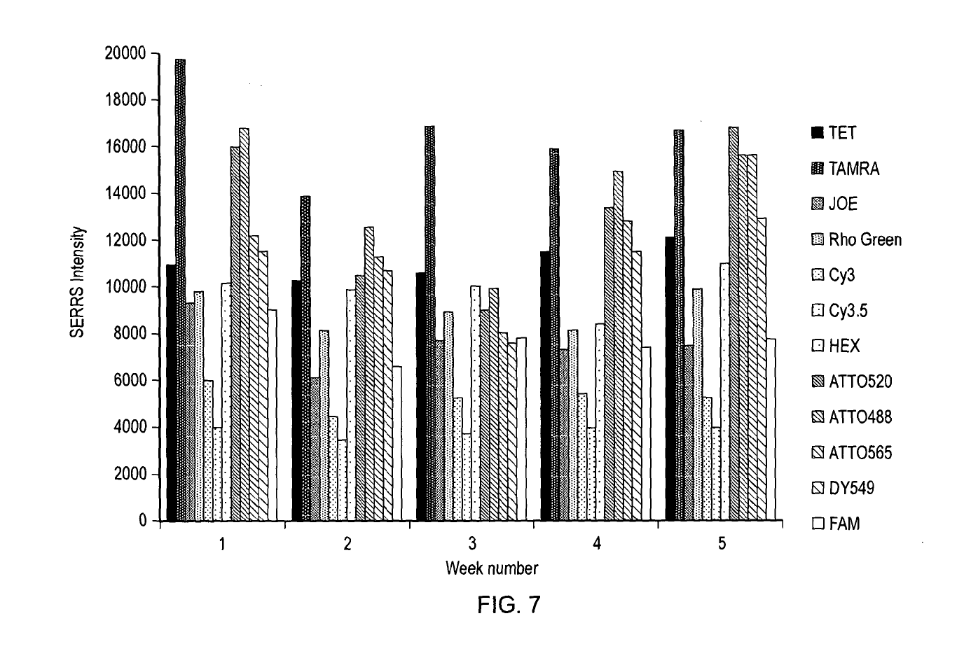

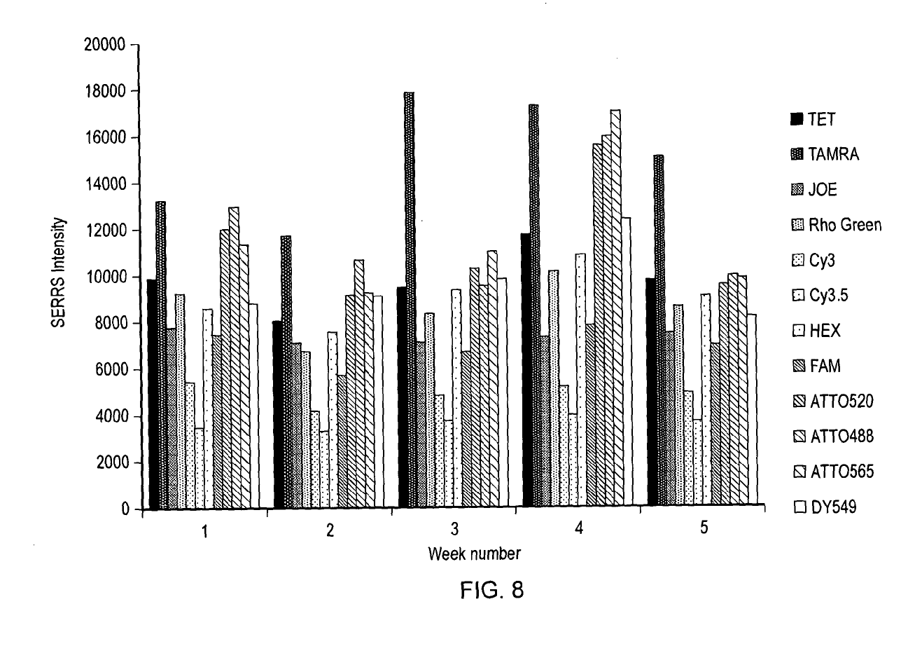

For all dyes, the average SERRS intensity was calculated and the results are shown in FIGS. 5 to 8 from week to week. FIGS. 5 and 6 are for air dried plates and FIGS. 7 and 8 are for lyophilised plates. In general, there is a fall in SERRS intensity between week 0 and week 4 but peaks are still sufficiently distinct in week 4.

Accordingly, from the above, it can be determined that the Raman peaks were reproducible after drying of the plates and after storage for 4 weeks. Therefore, the air dried or lyophilised dye labelled oligonucleotides can be used to create component reference spectra for calibrating Raman spectroscopy apparatus.

It will be understood that the invention is not limited to the above described embodiments and modifications and alterations can be made without departing from the scope of the invention as defined in the claims. For example, it is anticipated that other dyes may be used. Furthermore, SERRS may be carried out on naturally occurring biological matter comprising a chromophore and therefore, lyophilised or air dried reference plates may be formed from such matter without the need to attach a dye.

1. A method of calibrating spectroscopy apparatus comprising illuminating a reference sample, identifying a spectrum from light emitted from the sample and calibrating the spectroscopy apparatus based upon the spectrum, characterised in that the reference sample has been dried.

2. A method according to claim 1, comprising rehydrating the dried reference sample before illuminating the reference sample.

3. A method according claim 1, wherein the dried reference sample has been lyophilised on a substrate.

4. A method according to claim 1, wherein the reference sample is an organic reference sample.

5. A method according to claim 4, wherein the reference sample comprises dye labelled oligonucleotides.

6. A method according to claim 1, wherein the dried reference sample is treated with one or more reagents before illuminating the reference sample.

7. A method according to claim 6, wherein the reagents are the same reagents used to treat samples of unknown elements.

8. A method according to claim 6, wherein the reagents are used in substantially the same relative quantities as that used to treat the samples of unknown elements.

9. A method according to claim 6, wherein the reagents used are one or more selected from water, spermine and silver colloid.

10. A method according to claim 1, comprising identifying from scattered light a Raman spectrum for calibrating Raman spectroscopy apparatus.

11. A method according to claim 1, wherein the method steps are carried out automatically by the spectroscopy apparatus.

12. A method of calibrating spectroscopy apparatus comprising illuminating a reference sample, identifying a spectrum characteristic of the reference sample from light emitted from the sample and updating a library of component reference spectra with the spectrum characteristic of the reference sample.

13. A reference sample for use in calibrating spectroscopy apparatus, the reference sample comprising lyophilised dye labelled oligonucleotides and, optionally, comprises a substrate on to which the dye labelled oligonucleotides are lyophilised.

14. A kit for calibrating spectroscopy apparatus comprising labels for attaching to target molecules that are potentially present in an organic sample and a dried reference sample comprising the labels and organic matter.

15. A method of calibrating Raman spectroscopy apparatus comprising illuminating a reference sample, determining a Raman spectrum from light scattered from the sample and calibrating the Raman spectroscopy apparatus based upon the Raman spectrum, characterised in that the reference sample has been stabilized without significantly altering the Raman spectrum that is obtained from that which would have been obtained from the reference sample before the reference sample was stabilized.
